(19) United States
(12) Patent Application Publication
(10) Pub. No.: US 2013/0243669 A1
(43) Pub. Date: Sep. 19, 2013

(54) SAMPLE CONTAINER FOR STORING AND PROCESSING SAMPLES TAKEN WITH A SAMPLING TOOL

(71) Applicants: Laurent Baron, Frankreich (FR); Armin Panzer, Schweiz (CH); Flurin Gallmann, Schweiz (CH)

(72) Inventors: Laurent Baron, Frankreich (FR); Armin Panzer, Schweiz (CH); Flurin Gallmann, Schweiz (CH)

(73) Assignee: HAMILTON BONADUZ AG, Schweiz (CH)

(21) Appl. No.: 13/989,241

(22) PCT Filed: Nov. 24, 2011
(86) PCT No.: PCT/EP11/70969

§ 371 Date: May 23, 2013

(30) Foreign Application Priority Data
Nov. 26, 2010 (DE) 102010-062-064.5

(51) Int. Cl. B01L 3/00

(52) U.S. Cl. CPC B01L 3/508
USPC 422/547

(57) ABSTRACT

A sample container comprises a first container and a second container enclosing the first container, the containers capable of being brought into a storage position to form a collecting chamber therebetween having a first, smaller volume, and into an analysis position, in which the collecting chamber has a second, larger volume, wherein a fixing means is provided on the first container, which can be brought into fixing engagement with a mating fixing means provided on the second container such that relative motion of the containers is made more difficult in at least one relative motion direction and/or wherein a locking means is provided on the first container, which locking means can be brought into locking engagement with a mating locking means provided on the second container such that relative motion of the two containers is made more difficult in at least one relative motion direction.

The present invention relates to a sample container for storing and processing samples taken with a sampling tool, preferably samples comprising biological material, comprising a first container and a second container enclosing the first, the first and second containers being capable of being brought into a storage position relative to one another, in which a collecting chamber formed between the first and second containers has a first, smaller volume, and into an analysis position different from the storage position, in which the collecting chamber has a second, larger volume different from the first.

A sample container of said generic type is for example the device distributed by Promega Corporation under the trade name “Slicprep 96”.

Said device in each case comprises arrangements with 96 containers as first and second containers. The first containers, which are designated “spin baskets” in the Promega Slicprep 96 device, have a test tube-like shape with a cylindrical and/or conical circumferential surface and a bottom at one axial longitudinal end. These first containers, designated “spin baskets”, can be inserted in an insertion direction into second containers of a so-called “deep-well plate”. The second containers of the “deep-well plate” likewise have a test tube-like shape, but they have a larger diameter and a greater axial length, such that in each case one “spin basket” can be inserted as a first container into a second container of the “deep-well plate”.

The Slicprep 96 device further comprises a spacer frame which may if necessary be arranged between the two container arrangements in each case comprising 96 containers in order to enlarge and secure the axial spacing between each first and each second container of the two container arrangements.

In this manner, a collecting chamber is formed which is substantially enclosed by the bottom of the first container, by the bottom of the second container and by the portion of the circumferential wall of the second container located between the two bottoms.

Said collecting chamber serves to catch liquid initially present in the first container, for instance when the complete arrangement of “spin baskets”, “deep-well plate” and spacer frame is centrifuged and liquid is consequently expelled from the first container into the collecting chamber in the second container. Such devices are predominantly used in DNA analysis, a sample carrier with a substance to be analysed absorbed thereon initially being stored in the first container. A suitable lysis liquid, which converts the substance to be analysed present on the sample carrier into a state fit for analysis, is then added to said first container. This generally proceeds by incubation.

Once incubation is complete, the constituents which are fit for analysis of the liquid present in the first container are transferred by centrifugation under the action of centrifugal force into the second container, while those constituents which are not suitable for analysis or are even disruptive to analysis are retained in the first container. The first container is to this end constructed with appropriate permeability.

It is utterly essential for the reliability of such analyses for the sample carrier to be exposed to as little external disturbance as possible between sampling and analysis.

The object of the present invention is further to improve the sample container known from the prior art in this respect and thus to ensure the most reliable possible analytical results.

Said object is achieved according to the invention by a sample container of the above-mentioned type, in which a fixing means is provided on the first container, which fixing means can be brought, at least in the analysis position, into fixing engagement with a mating fixing means provided on the second container such that relative motion of the two containers is at least made more difficult in at least one relative motion direction from the analysis position, preferably towards the storage position, particularly preferably also away from the storage position, and/or in which a locking means is provided on the first container, which locking means can be brought, at least in the storage position, into locking engagement with a mating locking means provided on the second container such that relative motion of the two containers is at least made more difficult in at least one relative motion direction from the storage position, preferably towards the analysis position, particularly preferably also away from the analysis position.

Thanks to provision of fixing means and/or locking means on the first container and of mating fixing means and/or mating locking means on the second container, it is possible to fix or lock the first and the second container in at least one position selected from analysis position and storage position, preferably in both positions, without further components. Troublesome handling for arranging a spacing component and the like may accordingly be omitted.

The case in which, in the storage position of the first and second containers, the collecting chamber has a volume of 0 or virtually 0 is moreover intended to be included.

Furthermore, any mention of the relative mobility of the first and second containers at least being made more difficult is intended to mean that, in the corresponding relative position, relative mobility requires a greater driving force than if the fixing means or locking means with the corresponding mating means were not present.

While it is indeed possible in design terms to provide fixing means and mating fixing means for fixing engagement in the analysis position separately from locking means and mating locking means for locking engagement in the storage position, an equally good result may be achieved with lower manufacturing effort if the fixing means is the locking means and/or the mating fixing means is the mating locking means. Accordingly, one and the same fixing means on the first container, for example a latch projection, may for example enter into corresponding engagement with a mating fixing means and a mating locking means on the respective second container, for instance if both the mating fixing means and the mating locking means are in each case formed by latch recesses which are spaced apart from one another.

In order to ensure particularly secure fixing of the first and second containers in one or both of the stated relative positions, it may furthermore be provided that the fixing engagement and/or the locking engagement is a form-fitting engagement. The form-fitting engagement may be a form-fitting engagement which completely prevents further relative motion in at least one direction, for instance as is the case with a bayonet closure. In order to ensure that the respective relative position between first and second containers may likewise be reliably achieved and to make achieving said relative position perceptible, the fixing engagement and/or the locking engagement may be a latching engagement. In those cases in which the sample container is intended to be used repeatedly, it is advantageous for the fixing engagement and the locking engagement to be an overridable latching engagement.

The first and second containers may in principle be mobile relative to one another along any desired first relative motion path between the storage position and the analysis position. Mobility between the stated relative positions here also designates motion merely from one position to the respective other position, without the return motion in the contrary direction necessarily being possible.

In the above case which has already been mentioned of the sample container being reused, it may however be of assistance if the force exerted which transfers the two containers from one relative position into another also leads, at least with regard to the direction in which force is exerted, to release of the fixing or locking engagement. On the other hand, unintentional release of the fixing and locking engagement may be prevented in that, in at least one position selected from storage position and analysis position, preferably at least in the analysis position, particularly preferably in both positions, the first and second containers are mobile relative to one another along a second relative motion path which differs from the first in order to release the fixing engagement and/or the locking engagement.

The first and second containers preferably extend, as containers for laboratory use, along a common substantially linear container axis. For example, both the first and second containers have a bottom and a circumferential surface proceeding therefrom, the bottom of the first container particularly preferably exhibiting liquid permeability at least under predetermined operating conditions, for instance in order to be able to centrifuge the sample container.

It is then advantageous for the first and second containers to be mobile relative to one another along the common container axis as the first relative motion path between storage position and analysis position. By relative motion apart from one another in the axial direction, the two bottoms of the first and second containers are moved apart from one another in the axial direction, whereby the volume, which in this case is preferably located between the two container bottoms and the portion of the circumferential wall of the second, outer container between the two container bottoms, is formed. The collecting chamber is thus preferably located in the second container in the region of the bottom thereof.

In the preferred embodiment described herein, the first and second containers may then be rotated relative to one another in the circumferential direction about the container axis as the second relative motion path in order to release the fixing engagement and/or the locking engagement.

Latch lugs may for example be provided as fixing or locking means or as mating fixing means or mating locking means which, in one relative position, engage behind a latch recess as the mating locking means or mating fixing means or the fixing or the locking means. Then, by means of circumferential inclined faces on the latch recess, the latch lug may be moved by relative rotation of the first and second containers out of an engaged position, in which it is engaged mechanically behind a contour of the latch lug, and the fixing or locking engagement may thus be released.

Then, if a latch lug or a projection is provided on a container in resilient manner towards and away therefrom, automatic latching may particularly advantageously be ensured in that, between storage position and analysis position, said projection is pretensioned towards the respective other container. If at least one first latch recess for latching engagement with the projection is then provided on the respective other container at a first latching location, which is associated with a relative position selected from analysis position and storage position, the latching engagement may be effected automatically by the stated pretensioning by simple relative motion of the two containers.

In order to ensure that a latching engagement is possible at both relative positions of the first and second containers, a second latch recess for latching engagement with the projection is preferably provided on the respective other container at a second latching location remote from the first latching location in the direction of the first relative motion path. Said second latching location is then associated with the respective other relative position. In this way, one projection with two latch recesses can, as already indicated above, reliably fix or lock both containers of the sample container in the two intended relative positions.

In order to ensure accurate motion guidance, relative motion guide means may be provided on the first container, which guide means interact with mating relative motion guide means provided on the second container in order to guide the relative motion of the first and second containers along the first relative motion path between the storage position and the analysis position.

In order to simplify the design and to reduce the required number of components and/or geometric configurations on the two containers, it is feasible in a further development of the present invention for the relative motion guide means to be the fixing means and/or the locking means or for the mating relative motion guide means to be the mating fixing means and/or the mating locking means.

Guidance and latching may be achieved in design terms by fixing or locking means or the corresponding mating means thereof in that at least one projection is provided on one container selected from the first and second containers, which projection engages in, preferably passes through, a longitudinal groove extending along the first relative motion path on the respective other container, the longitudinal groove comprising at least one first latch lug arrangement at a first latching location which is associated with a relative position selected from analysis position and storage position, and the longitudinal groove preferably comprising a second latch lug arrangement at a second latching location, which is associated with the respective other relative position and is remote from the first latching location in the direction of the first relative motion path. The projection may thus serve both for latching the one container to the respective other container and for motion guidance.

As has already been explained above, the containers of the sample container of the present invention may be of a test tube-like or beaker-like construction with a bottom and a circumferential surface proceeding from the bottom. The first and second containers then each comprise a container opening, which openings are provided on corresponding sides, in particular on the same axial end sides of the respective container. Accordingly, when the present application mentions a first and a second container which extend along a common container axis, the second container surrounding the first container, surrounding is preferably taken to be in one of the axial directions and in the radial direction.

In the above-stated configuration of the two containers, the first container may be surrounded by the second container by the first container simply passing through the second container in at least one relative position selected from analysis position and storage position, preferably in both relative positions. Proceeding from the container bottom of the first container, the openings of both containers then lie in the same axial direction.

In order to be able to protect the taken sample from external influences on the sample container, the sample container may be provided with a removable lid which, when fitted to the sample container, covers the container opening of at least the first container. This is the container which is configured for accommodating the sample. Preferably, however, the lid fitted to the sample container covers both containers, such that the contents of the second container may also be provided with lasting protection from external influences.

Since, in order to store the sample in the first container, any lid provided on the sample container must in any event be removed from the latter, a compact, advantageously further developed sample container may be obtained in that the sampling tool is provided on the lid of the sample container. The lid with the sampling tool may then be removed from the sample container, the sample taken and the sampling tool with the lid arranged back on the sample container.

Handling of the sampling tool may also be improved in that it is provided on the lid so as to be mobile relative thereto.

The sampling tool may for example comprise a stick and a sample carrier provided detachably thereon. In this way, once the sample has been taken the sample carrier can be detached from the stick which is no longer required. The sample carrier is preferably arranged on a longitudinal end of the stick in order to facilitate sampling. The longitudinal end of the stick on which the sample carrier is detachably accommodated is, for the purpose of simply securing the sample, that longitudinal end which, when the lid is fitted to the sample carrier, is inserted in the first container.

In order to prevent contaminants from getting onto the sample from the stick, the latter is preferably detachable from the sample carrier, as has already been explained above. The sample carrier may here be detached from the stick without reopening the sample carrier in that the lid has a stripping geometry which, when the sampling tool is provided on the lid, permits relative motion of the stick relative to the stripping geometry but does not permit relative motion of the sample carrier, the stripping geometry preferably having the stick passing through it and surrounding the latter.

This particular solution of the strippable sample carrier is so advantageous that the applicant reserves the right to separate protection for a sample container having the features of the precharacterising clause of claim 1 as filed and the features of claims 13, 15, 16, 17 and 18 as filed. Said sample container may be provided with the developments explained above in detail in order to achieve the above-stated advantages.

When the stick has been withdrawn from the lid of the sample container for stripping the sample carrier from the stick, the latter, for example shortened, may be reinserted into a lid opening required for withdrawal of the stick in order to close said lid opening.

Preferably, however, the sample container comprises, independently of the stick, a stopper with which an opening provided in the lid, for instance for temporarily accommodating the sampling tool, may be closed, the stopper preferably being captive on the lid. The stopper is preferably made captive by providing a material connection between lid and stopper, for instance when using injection-moulded lids, which may comprise a captive stopper attached physically via a web connection.

It may be provided for the purpose of automated handling of the sample container described herein that the lid and/or the first container and/or the second container comprises a tool engagement geometry configured for tool engagement. A robot-actuated or otherwise automated tool may thus for example be brought into form-fitting engagement with the tool engagement geometry in order to carry out handling operations on the sample container in at least partially automated manner. For example, the lid of the sample container may be automatically removed and fitted back on again. Likewise, the first and second containers may automatically be brought by tool engagement into one or both of the stated relative positions.

In order to prevent contaminants from getting into the interior of the first and/or of the second container of the sample container under discussion as a result of tool engagement, it is preferred for the tool engagement geometry not to pass through the wall of the lid and/or container in which it is provided.

The present invention is described in greater detail below with reference to the appended figures, in which:

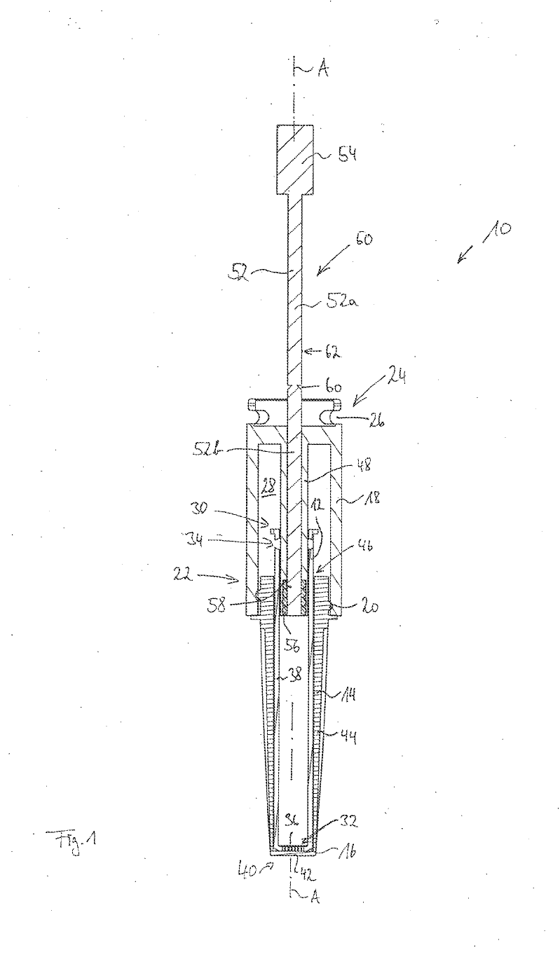

FIG. 1: shows a longitudinal sectional representation of a first embodiment according to the invention of a sample container of the present application,

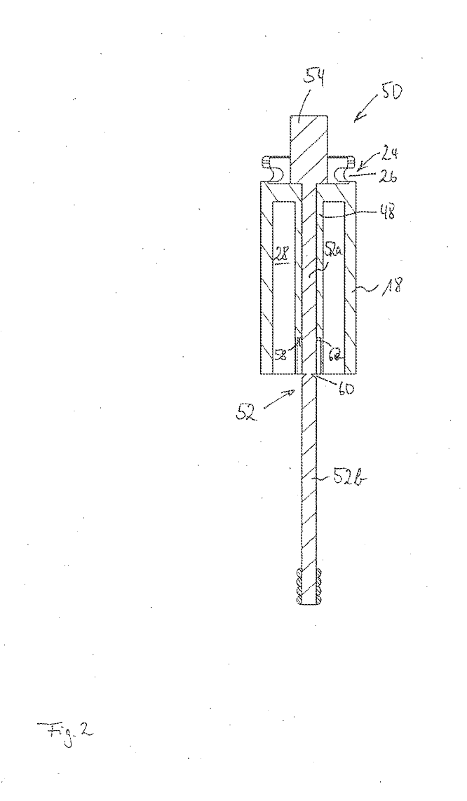

FIG. 2: shows the lid with sampling tool of the sample container of FIG. 1,

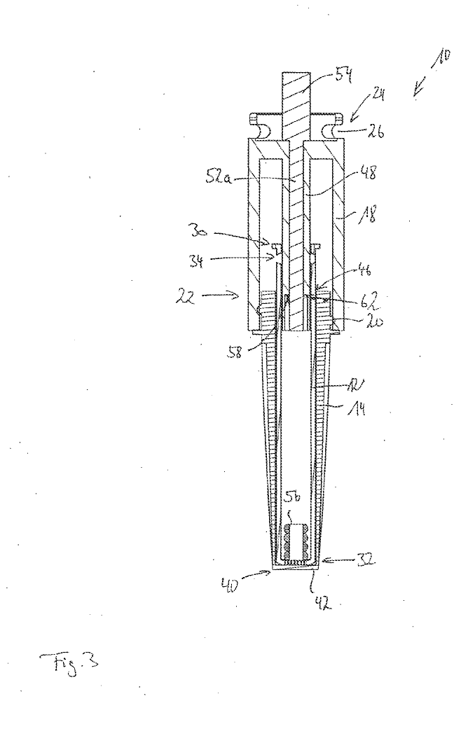

FIG. 3: shows the sample container of FIG. 3 in the storage position with stripped off sample carrier and shortened stick,

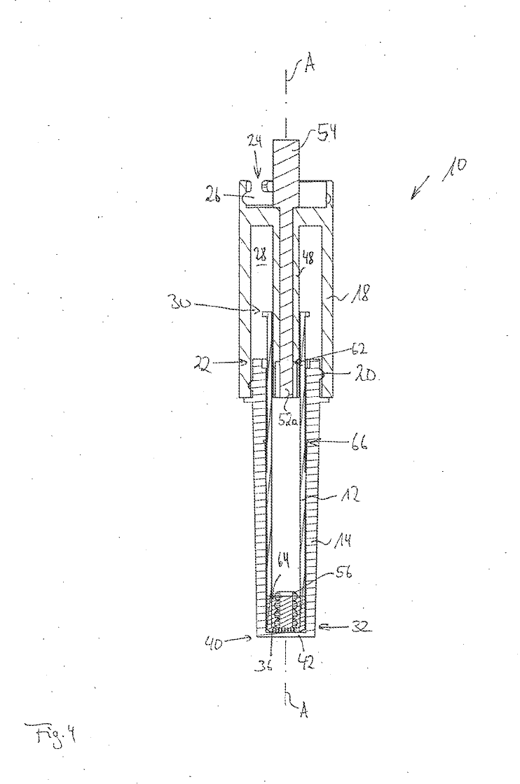

FIG. 4: shows the sample container of FIG. 3 with introduced lysis liquid,

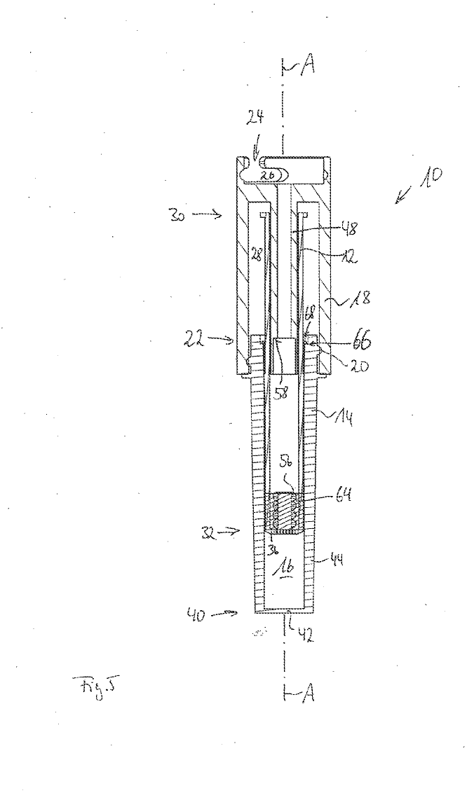

FIG. 5: shows the sample container in the analysis position,

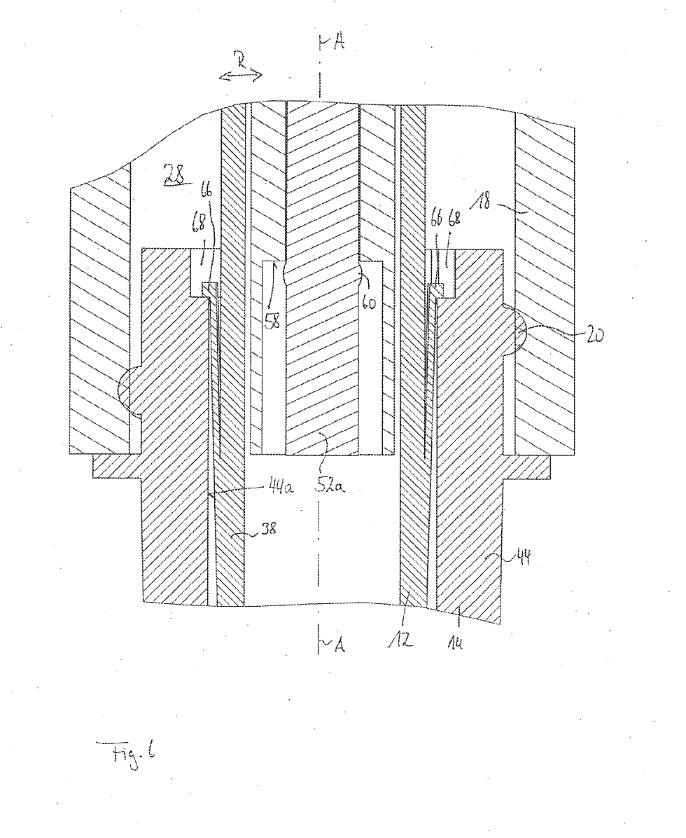

FIG. 6: shows a detail representation of the fixing engagement between first and second containers in the analysis position,

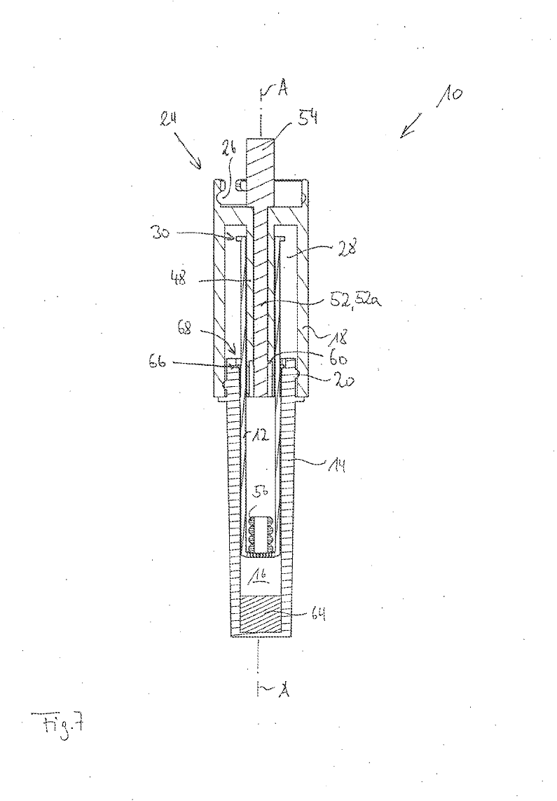

FIG. 7: shows the sample container in the analysis position after centrifugation,

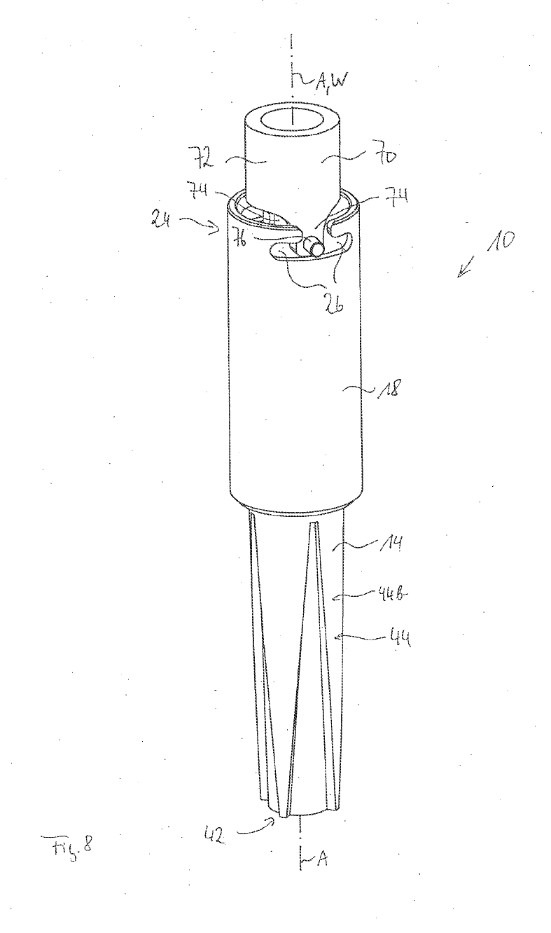

FIG. 8: shows a perspective representation of the sample container with lid and handling tool,

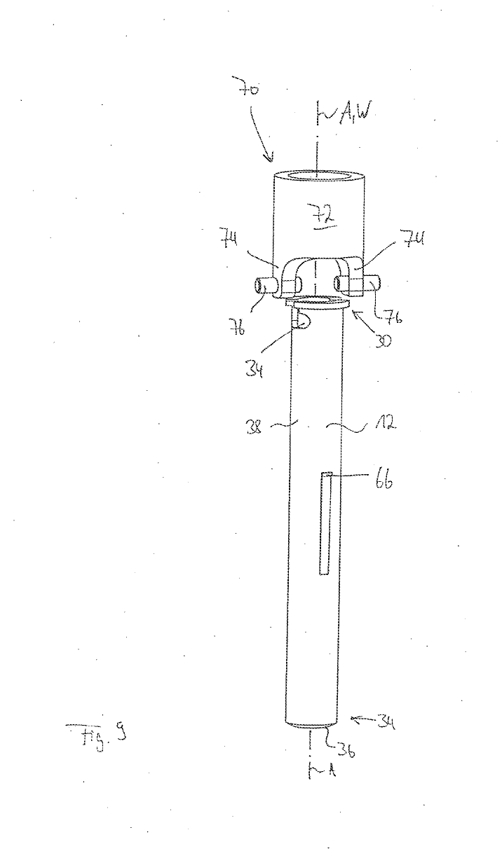

FIG. 9: shows the first container of the sample container with the handling tool of FIG. 9,

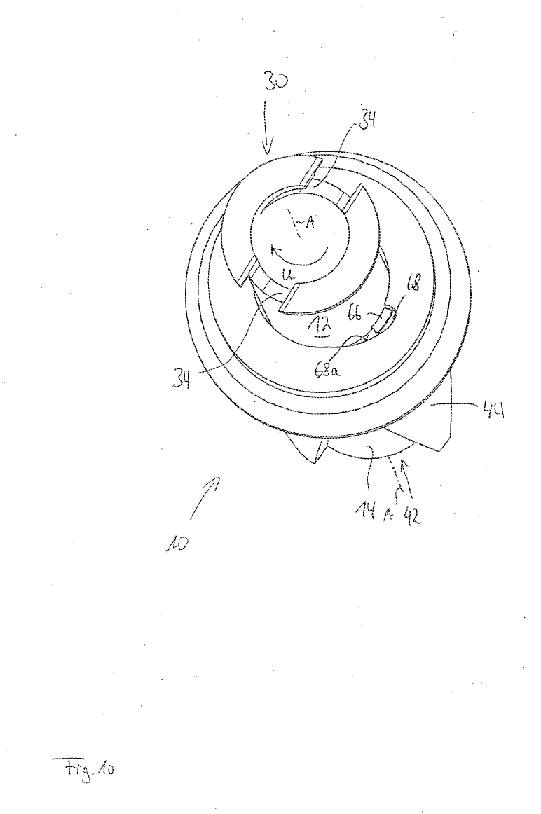

FIG. 10: shows a perspective view virtually from the direction of the container axis of the sample container,

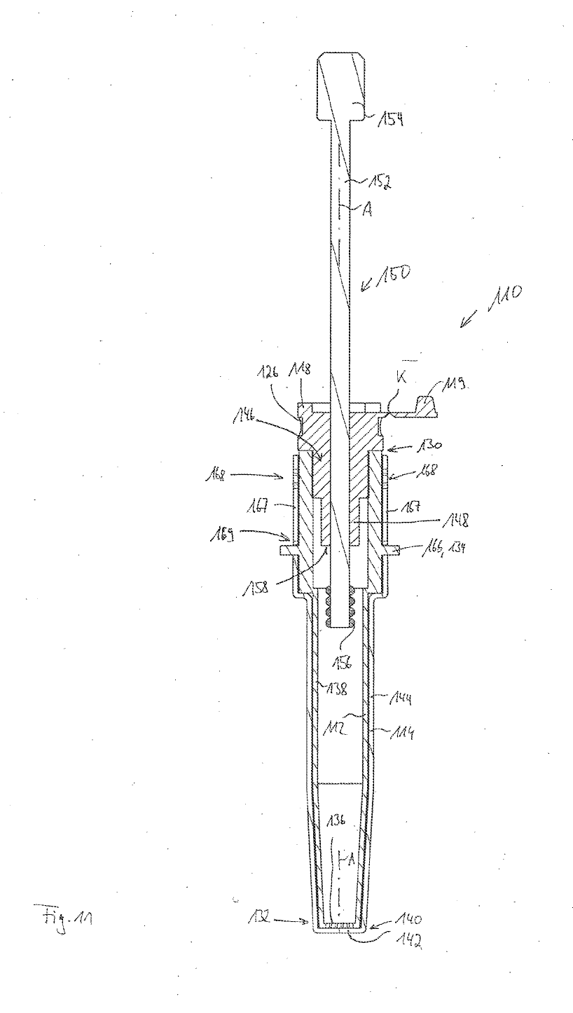

FIG. 11: shows a longitudinal sectional view of a second embodiment according to the invention of a sample container of the present invention,

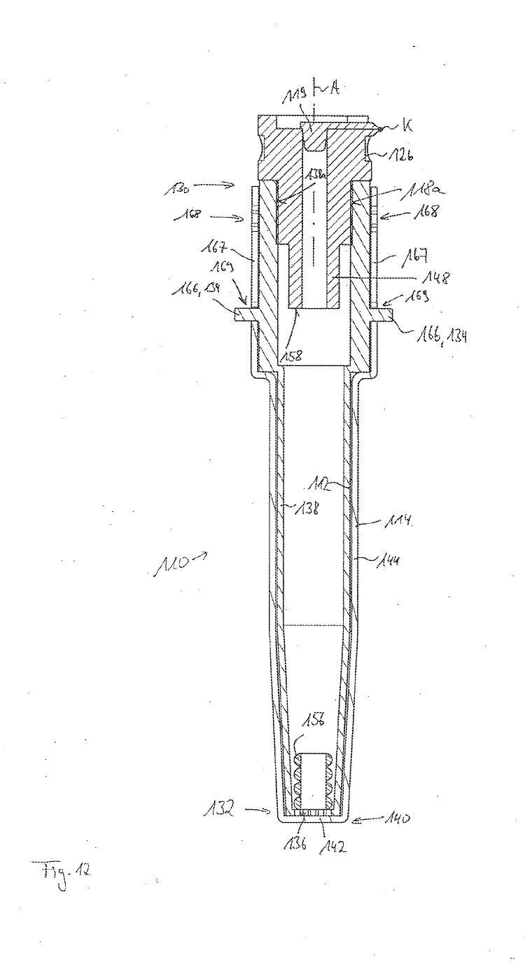

FIG. 12: shows the sample container of FIG. 11 with stripped off sample carrier and closed by a lid,

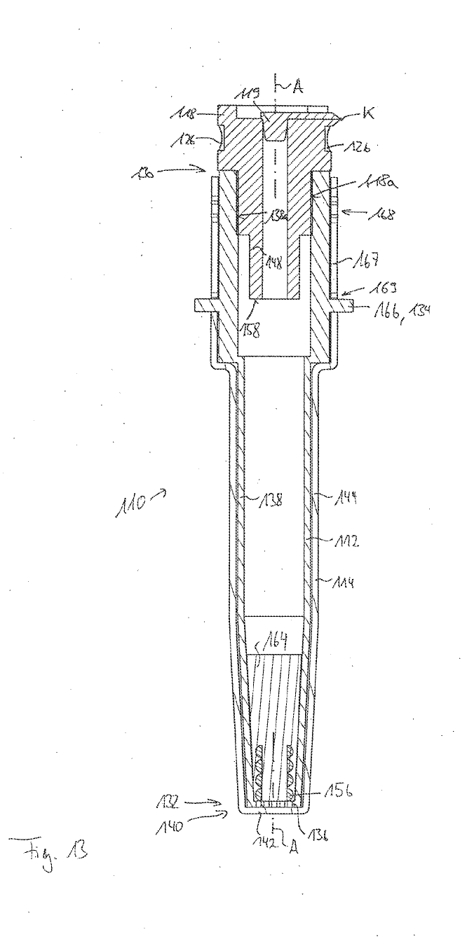

FIG. 13: shows the sample container of FIGS. 11 and 12 in the storage position after introduction of a lysis liquid,

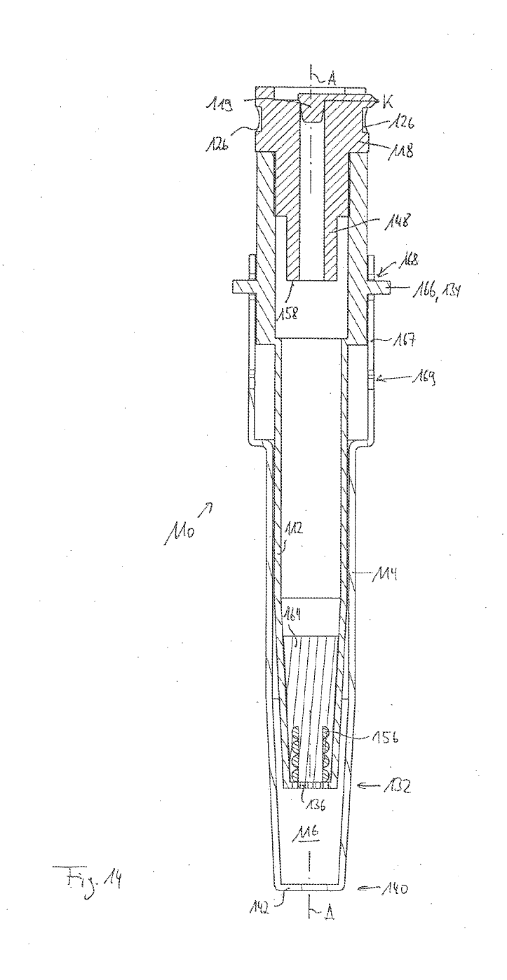

FIG. 14: shows the sample container of the second embodiment in the analysis position,

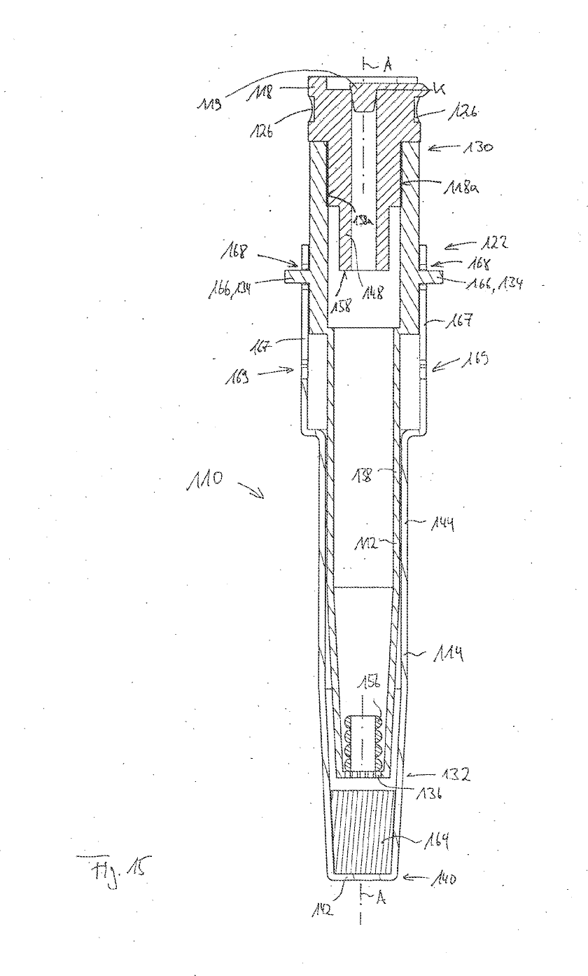

FIG. 15: shows the sample container of FIG. 14 after centrifugation,

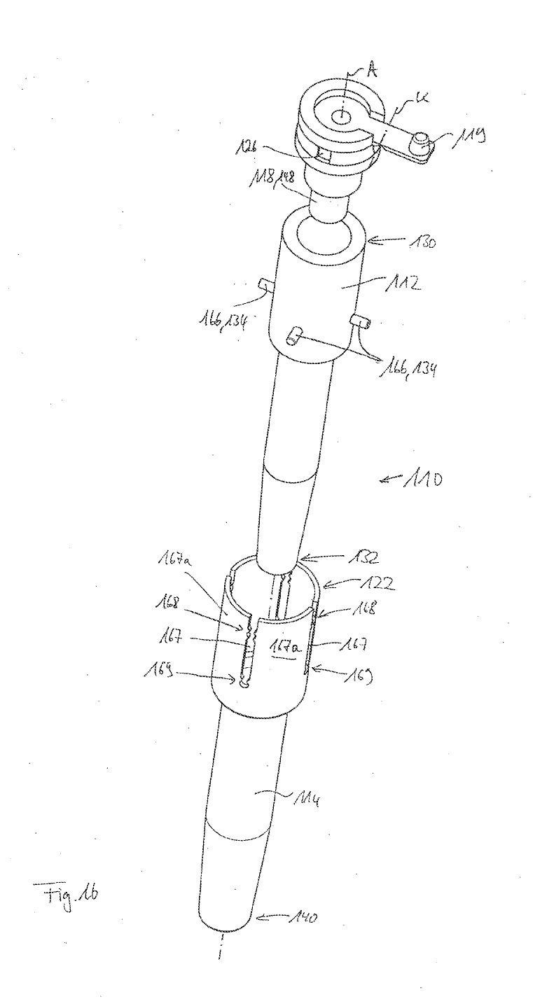

FIG. 16: shows a perspective exploded view of the sample container of the second embodiment and

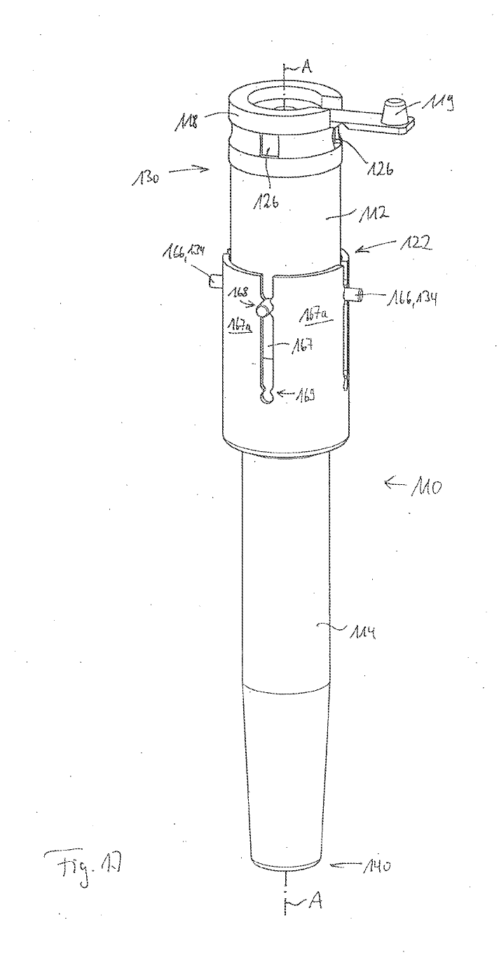

FIG. 17: shows a perspective external view of the sample container of the second embodiment in the analysis position.

In FIG. 1, a first embodiment according to the invention of a sample carrier of the present invention is denoted overall as 10. The sample carrier comprises a first, inner container 12 which is surrounded by a second, outer container 14.

The first and second containers 12 and 14 extend along a common container axis A, along which the first and second containers are mobile relative to one another.

In FIG. 1, the first and second containers 12 and 14 are shown in a storage position as one possible relative position of the two containers relative to one another, in which a collecting chamber 16, which may be present between the first and second containers 12 and 14, has a virtually infinitesimal, but in any event relatively small volume.

The sample container 10 furthermore comprises a lid 18 which may be screwed by means of a thread 20 radially outside relative to the container axis A onto the longitudinal end 22, located at the opening end, of the second container 14.

The lid 18 preferably comprises at the longitudinal end 24 thereof which is remote from the container a tool engagement geometry 26, in which an automation tool not shown in FIG. 1 may engage form-fittingly, in order to undo the screw fastening of the lid 18 to the second container 14 and to lift the lid 18 in the axial direction off the second container 14.

The lid 18 surrounds a preferably annular space 28, in which for example a desiccant may be accommodated for drying the sample carrier stored in the first container 12.

The first container 12 comprises one longitudinal end 30 located at the opening end and one longitudinal end 32 located at the bottom end. A tool engagement geometry 34 may be provided at the longitudinal end 30, located at the opening end, of the first container 12, in which geometry an automation tool may engage form-fittingly, for example in order to move the container 12 relative to the container 14 in an axial direction from the storage position shown in FIG. 1 into an analysis position described further below.

The first container 12 may comprise at its longitudinal end 32 located at the bottom end a bottom 36 which closes the container 12 axially, which bottom may be constructed with permeability in order to permit liquids to pass through the bottom 36 in predetermined operating states.

Proceeding in an axial direction from the bottom 36, the first container 12 may comprise a circumferential wall 38 which extends around the container axis A.

Like the first container 12, the second container 14 may also comprise, in addition to its longitudinal end 22 located at the opening end, a longitudinal end 40 located at the bottom end, on which a bottom 42 which closes the second container 14 axially may be constructed. Proceeding in an axial direction from the bottom 42 of the second container 14, a circumferential wall 44, which extends to the longitudinal end 22 located at the opening end, adjoins said bottom.

In this preferred embodiment, the first container 12 and the second container 14 are open towards the same axial end, the first container 12 preferably passing through an opening 46 of the second container 14.

The lid 18 may furthermore comprise a preferably central sleeve 48 which accommodates a sampling tool 50, preferably in mobile manner in an axial direction relative to the lid 18.

The sampling tool 50 may comprise a stick 52 which comprises at one end a handle portion 54 and at the other end, namely on a longitudinal end inserted into the first container 12, a sample carrier 56. The sample carrier 56 may be a sleeve or cap of absorbent material enclosing the relevant longitudinal end of the stick 52, said absorbent material for example comprising tangled fibres, such as for instance cotton wool, or an open-cell foam.

The sample carrier 56 is preferably provided detachably on the stick 52 and may be stripped off the stick 52 at a stripping geometry 58, for instance at an end face of the sleeve 48 of the lid 18, in such a manner that the sample carrier 56 remains in the first container 12.

The stick 52 of the sampling tool 50 comprises a portion 52a closer to the handle and a portion 52b closer to the sample carrier, which portions are joined together at a predetermined breaking point 60.

The stick 52 furthermore comprises in the region 52a thereof which is closer to the handle a peripheral latch projection 62 which is arranged such that the stick 52 or merely the portion 52a thereof which is closer to the handle may latch on the stripping geometry 58 when the stick 52 is axially completely inserted into the lid 18.

FIG. 2 shows the lid 18 with the sampling tool 50, specifically in the previously described position axially completely inserted into the lid 18 and latched with the stripping geometry 58.

The lid 18 with the sampling tool 50, as shown in FIG. 2, may be used for taking a sample by the corresponding handle portion 54 being held in the hand. Smear samples may accordingly be taken on the sample carrier 56 by the sampling tool 50.

FIG. 3 shows the sample container 10 with stripped off sample carrier 56, which is stored in the interior of the first container 12.

After stripping off the sample carrier 56 at the predetermined breaking point 60, the stick 52 was shortened and reinserted into the sleeve 48 in order to close the latter and thus the lid 18. The peripheral latch projection 62 latches with the stripping geometry 58 and thus ensures that the stick 52 is securely retained in the lid 18.

FIG. 4 substantially shows the sample carrier 10 of FIG. 3 but with a section plane rotated just slightly about the container axis A, a lysis liquid 64 having now been introduced into the first container 12. Introduction of the lysis liquid 64 may proceed either through the central sleeve 48 with withdrawal of the remaining portion 52a, which is closer to the handle, of the stick 52 or by removal of the complete lid 18.

FIG. 4 shows latch projections 66 which are provided resiliently in the radial direction relative to the container axis A on the first container 12 and which will be addressed in detail further below.

FIG. 5 shows the sample container 10 of FIG. 4, but without the portion 52a which is closer to the handle of the stick 52.

In contrast to the storage position as the relative position in which the first and second containers 12 and 14 are located in FIG. 4 and in which, after introduction of the lysis liquid 64, the sample carrier 56 is incubated, FIG. 5 shows the first container 12 and the container 14 in an analysis position in which the first container 12 is withdrawn somewhat from the second container 14 in the axial direction relative to the second container 14, such that the volume of the collection chamber 16, which is located substantially between the bottoms 36 and 42 of the first container 12 and of the second container 14 and the portion of the circumferential wall 44 located axially between said bottoms 36 and 42 of the second container 14, is significantly enlarged relative to the volume thereof in the storage position of the sample container 10.

In order to secure the analysis position shown in FIG. 5 between the first container 12 and second container 14, a latch recess 68 for each latch projection 66 is provided at the longitudinal end 22 located at the opening end of the second container 14, in which latch recess the latch projection 66 engages in the analysis position of the containers 12 and 14. This is shown in detail in FIG. 6.

The latch projection 66, two of which are formed diametrically opposite one another on the radially outer side of the circumferential wall 38 of the first container 12, are of leaf spring-type construction and resilient in the radial direction R.

At least when the containers 12 and 14 approach the analysis position thereof, the latch projections 66 are radially outwardly pretensioned against the spring force of the material resilience thereof by the inner surface 44a of the circumferential wall 44 of the second container 14, against which the latch projections 66 rest, such that when said latch projections reach the latch recess 68 they automatically penetrate radially therein and engage behind said recess in such a manner that the first container 12 cannot be returned to the storage position relative to the second container 14, as shown in FIGS. 1 to 4, by simple exertion of force in the axial direction without the sample container 10 being destroyed.

FIG. 7 shows the sample container 10 of FIG. 5 with the remainder of the stick 52 inserted in the lid 18 after centrifugation, whereby the lysis liquid 64 with the sample constituents intended for analysis dissolved therein has passed through the bottom 36 of the first container 12 into the collecting chamber 16.

FIG. 8 shows a perspective view of the sample container 10 with a handling tool 70, which is constructed for tool engagement both with the tool engagement geometry 26 of the lid 18 and for tool engagement with the tool engagement geometry 34 of the first container 12.

The handling tool 70 may here comprise a substantially cylindrical tool body 72 with an axial functional extension 74 thereon. For reasons of symmetrical introduction of force, the handling tool 70 preferably comprises two functional extensions 74 which are preferably located opposite one another relative to the container axis A.

Due to its substantially cylindrical form, the tool body 72 may also have a tool axis W which should be brought into line with the container axis A for the form-fitting engagement of the handling tool 70 with the tool engagement geometries 26 and 34 of the sample container 10.

A radial engagement projection 76 may be provided on the axial functional extensions 74, which projection may be brought into form-fitting engagement with the tool engagement geometries 26 or 34 by rotation of the handling tool 70 about the tool axis W or about the container axis A, in a similar manner to a form-fitting engagement known from a bayonet closure.

The radial engagement projection 76 preferably passes through the axial functional extension 74, such that the projection protrudes both radially outwards and radially inwards therefrom.

Consequently, both the lid 18 and the first container 12 may be gripped and handled by one and the same handling tool 70.

FIG. 8 further shows that the outside 44b of the circumferential wall 44 of the second container 14 may comprise guide geometries which may in particular comprise insertion bevels in order, on axial introduction of the sample container 10 with the second container 14 or of the second container 14 alone into a corresponding holder, to be able to obtain a defined orientation of the second container 14 and thus also of the sample container 10.

FIG. 9 shows the handling tool 70 immediately before the form-fitting engagement of the radial inwardly protruding portions of the radial projections 76 with the tool engagement geometries 34 at the longitudinal end 30, which is located at the opening end, of the first container 12. Here too, tool engagement and the production of a form-fitting coupling between the handling tool 70 and the first container 12 proceeds in the manner of a per se known bayonet closure.

Although, for reasons of greater clarity, FIG. 9 shows a tool engagement geometry 34 which passes through the circumferential wall 38 of the first container 12, this is not preferred.

It is in contrast preferred to form the tool engagement geometry 34 as a groove on the outside of the circumferential wall 38 of the first container 12, such that it is impossible for the handling tool 70 to have an influence in the interior of the first container 12 in the event of tool engagement with the first container 12.

FIG. 10 shows the sample container 10 without a lid, thus only the first container 12 and the second container 14.

It may be noted here that the latch recess 68 may comprise an inclined face 68a in a circumferential direction, such that, by rotating the first container 12 relative to the second container 14 in the direction U about the container axis A, the latch projection 66 may be forced radially inwards and brought out of engagement with the latch recess 68. It is consequently possible to move the first container 12 relative to the second container 14 from the analysis position back into the storage position and optionally make renewed use thereof, for instance if the same sample is to be incubated and analysed once again because a first measurement, for whatever reason, was not usable.

FIG. 11 shows a second embodiment of a sample container according to the invention. This second embodiment, in which identical and functionally identical components have the same reference numerals as in the first embodiment, but incremented by 100, is described hereinafter only insofar as it differs from the first embodiment, to the description of which reference is otherwise explicitly made.

In contrast to the first embodiment, in the second embodiment of the sample container 110 according to the invention the lid 118 is inserted radially inwards into the longitudinal end 130, which is located at the opening end, of the first container 112.

The stick 152 is of simplified one-piece construction, without a predetermined breaking point, although such a predetermined breaking point may be provided.

Said predetermined breaking point is, however, not required in the solution according to the second embodiment, since the lid 118 is integral with a stopper 119 which is pivotable about a pivot axis K oriented orthogonally to the plane of the drawing of FIG. 11. After removal of the stick 152 from the substantially central sleeve 148, said stopper 119 may be inserted into the opening of the sleeve 148 by pivoting about the pivot axis K.

Furthermore, in contrast to the first embodiment, the radial latch projection 166 as the fixing and locking means of the first container 112 is no longer connected resiliently in the radial direction to the first container, but instead rigidly. The radial latch projection 166 may furthermore act as a tool engagement geometry 134 for introducing relative motion between first and second containers 112 and 114 by an appropriate handling tool which is not shown in FIG. 11.

The radial latch projection 166 is guided in a groove 167 of the circumferential wall 144 of the second container 114.

The groove 167 or the plurality of grooves 167 acts, on the one hand, to guide a relative motion of the first and second containers 112 and 114 between the storage position shown in FIG. 11 and the analysis position described further below (see FIGS. 14 and 15).

Each of the provided grooves 167 comprises a first latch lug arrangement 168 which is associated with the analysis position and with which the in each case associated latch projection 166 is thus in latching engagement when the first and second containers 112, 114 are in the analysis position relative to one another, and comprises a second latch lug arrangement 169 provided at a distance therefrom along the relative motion path between the two containers, which second latch lug arrangement is associated with the storage position and with which the respective latch projection 166 is in latching engagement when the first and second containers 112 and 114 are in the storage position relative to one another.

The groove 167 or the plurality of grooves 167 have a width in the circumferential direction about the container axis A which is sufficiently large for the latch projection to be mobile in the axial direction but not to be mobile in the circumferential direction, in order ensure that the groove 167 has a motion guidance action.

FIG. 12 shows the sample container 110 after the sample carrier 156 has been stripped off, the lid 118 being closed with the stopper 119.

The lid 118 may be fitted particular securely by being screwed into the first container 112 with an external thread 118a into an internal thread 138a on the inside of the circumferential wall 138.

The operating state of the sample container 110 of the second embodiment of FIG. 12 thus substantially corresponds to the operating state of the sample container 10 of the first embodiment as shown in FIG. 3.

FIG. 13 substantially shows the sample container 110 of FIG. 12, but with lysis liquid 164 introduced into the first container 112. Lysis liquid 164 is introduced into the first container 112 for this purpose either through the central sleeve 148 or by removing and replacing the lid 118.

The operating state of the sample container 110 of the second embodiment shown in FIG. 13 substantially corresponds to the operating state of the first sample container 10, as shown in FIG. 4. In this position, the sample carrier 156 containing sample substance thereon may be incubated.

FIG. 14 shows the sample container 110 of the second embodiment with first and second containers 112 and 114 in the analysis position.

The first container 112 was to this end moved relative to the second container 114 in the axial direction along the common container axis A until the radial latch projections 166 are latched in what in FIG. 14 is the upper latch lug arrangement 168.

In this way, a collecting chamber 116 was formed, or the volume thereof was enlarged, axially between the container bottom 136 of the first container 112 and the container bottom 142 of the second container 114, such that lysis liquid 164 is capable of passing by centrifugation through the bottom 136 of the first container 112 into the collecting chamber 116.

This preparatory state for centrifugation is shown in FIG. 14, the operating situation of which corresponds to the operating situation of the sample container 10 of the first embodiment in FIG. 5.

The situation after centrifugation, namely with lysis liquid 164 collected in the collecting chamber 116, is shown in FIG. 15, the operating situation of the sample container 110 of the second embodiment of FIG. 15 corresponding to that of the sample container 10 of the first embodiment of FIG. 7.

FIG. 16 shows a perspective exploded view of the sample container 110. The four radial latch projections 166 on the first container 112 and the associated latch recesses or grooves 167 on the second container 114 which are provided in the present example are clearly evident.

Segments 167a located between the adjacent grooves 167 are thus formed which, together with an appropriately selected height of the latch lugs of the latch lug arrangements 168 and 169 which permit overridable latchability of the radial latch projections 166 in the respective relative positions.

FIG. 17 shows a perspective view of the sample container 110 of the second embodiment, in which the first container 112 is in the analysis position relative to the second container 114. This is evident from the latching of the radial latch projections 166 of the first container 112 in the latch lug arrangements 168 which are located closer to the longitudinal end 122, which is located at the opening end, of the second container 114.

As is furthermore evident, the first container 112 may either be adjusted relative to the second container 114 from the analysis position back into the storage position by overriding the provided latching or be removed from the second container 114 by exerting substantially the same force in the opposite direction.

In contrast to the latch lug arrangement 168, in the second exemplary embodiment shown, the latch lug arrangement 169 and the consequently formed latching location are configured such that, proceeding from the storage position associated with said latching location, solely an axial motion towards the analysis position is possible.

1. A sample container for storing and processing samples taken with a sampling tool comprising a first container and a second container enclosing the first container, the first and second containers being capable of being brought into a storage position relative to one another, in which a collecting chamber formed between the first and second containers has a first, smaller volume, and into an analysis position different from the storage position, in which the collecting chamber has a second, larger volume different from the first, smaller volume, wherein
a fixing means is provided on the first container, which fixing means can be brought, at least in the analysis position, into fixing engagement with a mating fixing means provided on the second container such that relative motion of the two containers is at least made more difficult in at least one relative motion direction from the analysis position, and/or in that a locking means is provided on the first container, which locking means can be brought, at least in the storage position, into locking engagement with a mating locking means provided on the second container such that relative motion of the two containers is at least made more difficult in at least one relative motion direction from the storage position.

2. A sample container according to claim 1, wherein the fixing means is the locking means and/or in that the mating fixing means is the mating locking means.

3. A sample container according to claim 1, wherein the fixing engagement and/or the locking engagement is a form-fitting engagement.

4. A sample container according to claim 1, wherein the fixing engagement and/or the locking engagement is a latching engagement, preferably an overridable latching engagement is.

5. A sample container according to claim 1, wherein the first and second containers are mobile relative to one another along a first relative motion path between the storage position and the analysis position.

6. A sample container according to claim 5, wherein, in at least one position selected from storage position and analysis position, preferably at least in the analysis position, particularly preferably in both positions, the first and second containers are mobile relative to one another along a second relative motion path which differs from the first in order to release the fixing engagement and/or the locking engagement.

7. A sample container according to claim 5, wherein the first and second containers extend along a common container axis and the first and second containers are mobile relative to one another along the common container axis as the first relative motion path between storage position and analysis position.

8. A sample container according to claim 6, wherein the first and second containers extend along a common container axis and the first and second containers are mobile relative to one another along the common container axis as the first relative motion path between storage position and analysis position, and wherein the first and second containers may be rotated relative to one another in circumferential direction about the container axis as the second relative motion path in order to release the fixing engagement and/or the locking engagement.

9. A sample container according to claim 5, wherein a projection is provided on one container selected from the first and second containers, preferably is provided in resilient manner towards the respective other container and away therefrom, particularly preferably is provided between storage position and analysis position in pretensioned manner towards the respective other container, and in that on the respective other container at a first latching location, which is associated with a relative position selected from analysis position and storage position, at least one first latch recess for latching engagement with the projection is provided, a second latch recess preferably being provided on the respective other container at a second latching location, which is associated with the respective other relative position and is remote from the first latching location in the direction of the first relative motion path, for latching engagement with the projection, and optionally wherein the fixing engagement and/or the locking engagement is a form-fitting engagement and/or optionally wherein the fixing engagement and/or the locking engagement is a latching engagement, preferably an overridable latching engagement.

10. A sample container according to claim 5, wherein relative motion guide means are provided on the first container, which guide means interact with mating relative motion guide means provided on the second container in order to guide the relative motion of the first and second containers along the first relative motion path between the storage position and the analysis position.

11. A sample container according to claim 10, wherein the relative motion guide means are the fixing means and/or the locking means or in that the mating relative motion guide means are the mating fixing means and/or the mating locking means.

12. A sample container according to claim 10, wherein at least one projection is provided on one container selected from the first and second containers, which projection engages in, preferably passes through, a longitudinal groove extending along the first relative motion path on the respective other container, the longitudinal groove comprising at least one first latch lug arrangement at a first latching location which is associated with a relative position selected from analysis position and storage position, and the longitudinal groove preferably comprising a second latch lug arrangement at a second latching location, which is associated with the respective other relative position and is remote from the first latching location in the direction of the first relative motion path.

13. A sample container according claim 1, wherein the first and second containers each comprise a container opening, which openings are provided on corresponding sides of the first and second containers, preferably, in the event of containers extending along a container axis, are located on the same axial end side of the respective container.

14. A sample container according to claim 13, wherein the first container passes through the container opening of the second container in at least one relative position selected from analysis position and storage position, preferably in both relative positions.

15. A sample container according to claim 13, wherein it comprises a removable lid which, when fitted to the sample container, covers the container opening of at least the first container, preferably of both containers.

16. A sample container according to claim 15, wherein the sampling tool is provided on the lid, preferably in mobile manner relative to the lid.

17. A sample container according to claim 16, wherein the sampling tool comprises a stick and a sample carrier provided detachably thereon, which is preferably provided at a longitudinal end of the stick which, when the lid is fitted to the sample carrier, is inserted in the first container.

18. A sample container according to claim 17, wherein the lid has a stripping geometry which, when the sampling tool is provided on the lid, permits relative motion of the stick relative to the stripping geometry but does not permit relative motion of the sample carrier, the stripping geometry preferably having the stick passing through it.

19. A sample container according to claim 16, wherein it comprises a stopper, with which an opening provided in the lid, which, when the sampling tool is provided on the lid, is passed through by the sampling tool, may be closed, the stopper preferably being captive on the lid.

20. A sample container according to claim 1, wherein the lid and/or the first container and/or the second container comprises a tool engagement geometry configured for tool engagement.

21. A sample container according to claim 20, wherein the tool engagement geometry does not pass through the wall of the lid and/or container in which it is provided.
